(19) United States
(12) Patent Application Publication
(10) Pub. No.: US 2013/0100308 A1
(43) Pub. Date: Apr. 25, 2013

(54) TURBULENCE COMPENSATED IMAGE PRODUCTION

(71) Applicant: Klamer Schutte, Zoetermeer (NL)

(72) Inventor: Klamer Schutte, Zoetermeer (NL)

(21) Appl. No.: 13/638,842

(22) PCT Filed: Apr. 1, 2011
(86) PCT No.: PCT/NL2011/050222

§ 371 Date: Dec. 17, 2012

(30) Foreign Application Priority Data
Apr. 1, 2010 (EP) 10158992.7

(51) Int. Cl. H04N 5/235

(52) U.S. Cl. CPC H04N 5/235
USPC 348/222.1

(57) ABSTRACT

Turbulence compensated image data is produced by adapting the settings of a deformable mirror (4) or other adaptable optical element that is used to in the formation of images of an object. A series of images produced by the camera (3) is captured with different adaptations the deformable mirror (4). Turbulence is estimated from the series of images. Compensated image data is computed, by compensating the turbulence in at least one image after the at least one image has been captured by the camera, by using the estimated turbulence and a turbulence compensation computation algorithm. The compensated image data may be computed using a maximum likelihood estimation of the image data given an expression for the likelihood of the object parameters that are representative of compensated image data and aberration parameters due to turbulence given the captured images and the adaptations to the deformable mirror (4) at the times that the images were captured

### FIELD OF THE INVENTION

The present invention relates to the production of turbulence compensated image data. More in particular, the present invention relates to a device for and a method of producing turbulence compensated image data.

### BACKGROUND

It is well known that atmospheric turbulence can deteriorate the quality of images. Turbulence influences the path of light and causes images to be locally out-of-focus. Turbulence may also have other detrimental effects on images, for example scintillation. Various solutions have been proposed to compensate turbulence. Most of these solutions involve feedback: the amount of turbulence detected in received light is used to alter the optics in the light path in a way that reduces the effect of turbulence on focussing.

Such a feedback system is described in an article by Zhijun Zhao et al, titled “Adaptive Optical Communication through Turbulent Atmospheric Channels” published in the IEEE International Conference on Communications 2008 (ICC'08) Piscataway N.J., USA pages 5432-5436 (EPO reference XP031266339).

Zhao et al describes an optical communication system with an optical transmitter and an optical receiver with adaptive optics. The adaptive optics are used for beam control. The control settings of the adaptive optics are adapted using a stochastic parallel gradient descent algorithm. This involves repeated updates with random patterns of adjustment, each pattern multiplied with an amplitude and sign in proportion to the difference between the total intensity measured when the random pattern and its opposite are used respectively. Zhao detects intensity as a function of position and processes it to determine the total intensity. Zhao et al show that the beam at the receiver can be narrowed in this way. The narrowed beam is used to transmit a temporal data stream. Zhao does not discuss further processing of the intensity as a function of position.

Zhao is only concerned with optimized beam width, not with optimized images formed on the receiver. The settings of the adaptive optics obtained with the feed back process arguably could have the effect of improved imaging in a part of an image at the receiver that represents objects in direction of the transmitter, but for other parts of the image that represent objects from other directions, optimal imaging is not guaranteed.

U.S. Pat. No. 6,163,381 (TRW) discloses a dual sensor wave front correction system comprising a real reconstructor which provides an estimation of the distortion in the wave front during most conditions, except for conditions of severe turbulence, for which a complex reconstructor is provided. The reconstructors provide a composite correction signal to the actuators of a deformable mirror. This known correction system produces a corrected light beam by attempting real time feedback.

The paper “Imaging through turbulence using compressive coherence sensing” by A. A. Wagadarikar et al. discloses an imaging technique in which sparse objects imaged through turbulence are estimated. The Wagadarikar paper suggests to use a deformable mirror in an adaptive optics system to remove any aberrations caused by the turbulence. In other words, feedback is used to produce an improved image.

Although the above techniques are useful, it has been found that feedback may introduce problems. If the feedback is delayed, the image compensation is incorrect and the distortions caused by turbulence are not removed. In addition, inaccuracies in the feedback loop may introduce oscillations, which also lead to image errors.

Different settings of the deformable mirror may optimize focus for different parts of the objects that are visible in an image. The settings of the deformable mirror obtained with a feedback process result in a setting of the deformable mirror with average improved focus for all of the visible objects, or optimal focus for part of the visible objects that are visible. But optimal focus for all objects is not realized.

It is an object to overcome at least one of or other problems of the Prior Art.

A device for and method of producing turbulence compensated image data is provided in which a feedback loop can be omitted.

Accordingly, a device for producing turbulence compensated image data is provided, the device comprising:
a processor,
a memory for storing processor-executable instructions,
a camera for producing images, and
an adaptive optical element for altering properties of light incident on the camera,

wherein the processor is configured to control the adaptive optical element, and wherein the processor-executable instructions are configured to make the processor carry out the steps of:
registering a series of images produced by the camera while adapting the optical element, whereby images are registered that are obtained with mutually different adaptations of the optical element;
estimating turbulence affecting the images in the registered series of images from the series of images, and
computing compensated image data, by compensating the turbulence in at least one image after the at least one image has been captured by the camera, by using the estimated turbulence and a turbulence compensation computation algorithm.

By registering a series of images obtained with different adaptations of the optical element (4), each presumably being affected by a slightly different turbulence state of the atmosphere, the actual turbulence can be estimated. Using this estimated actual turbulence, the processor can compensate at least one image, typically but not necessarily the “best” image in terms of focus and other properties. A plurality of images may be used each for providing a different region of the compensated image, typically but not necessarily the “best” images in terms of focus and other properties in the respective regions.

In captured images isoplanatic regions (also called isoplanatic patches or isoplanatic angles) can be distinguished within which the image is affected substantially in the same way by turbulence. The estimation of turbulence may provide for estimations of turbulence that distinguish between different isoplanatic regions. The respective isoplanatic regions of the at least one image may each be computed using compensation for the different estimations of turbulence for the respective isoplanatic regions.

It is noted that the corrected image data is computed by compensating the turbulence. The device does not attempt to capture a better (that is, turbulence compensated) image as in the Prior Art, where the adaptive optical element serves to compensate the image before it is captured by the camera. In contrast, the image is compensated after being captured by the camera, and the adaptive optical element serves to introduce distortions rather than eliminating them.

In a preferred embodiment, the processor-executable instructions are configured for estimating turbulence using a phase diversity technique. Such techniques allow turbulence to be estimated effectively.

Alternatively, or additionally, the processor-executable instructions may be configured for carrying out the step of compensating turbulence using a compressive sensing technique. Compressive sensing is a technique which allows information to be reconstructed from a low number of samples, typically significantly less samples than required according to the Nyquist/Shannon criterion. Reference is made to the article by Emmanuel Candès and Michael Wakin, “An introduction to compressive sampling”, IEEE Signal Processing Magazine, 25(2), pp. 21-30, March 2008, which is herewith incorporated in this document.

Alternatively, or additionally, the processor-executable instructions may be configured for carrying out the step of compensating turbulence using a suitable interpolation technique.

The processor-executable instructions may further be configured for making the adaptive optical element produce an image space which comprises the optimal configuration of the adaptive optical element. It will be understood that the image space (with the word “space” being used in the mathematical sense) is produced by a plurality of (preferably distinct) images.

The adaptive optical element may comprise a deformable mirror, which is known per se.

The present device and method may be summarised as follows. The device comprises an adaptive optical element, such as a deformable mirror, of which the optical properties are varied in time. Varying the optical properties of the adaptive optical element results in variations, such as variations in focus, of the images. The adaptive optical element may produce random variations, or may produce dedicated variations. The images resulting from the variations are used to estimate the current turbulence and/or a compensated image. At least one image may be compensated using the estimated turbulence. Estimating the turbulence may be achieved using a phase diversity interpolation technique which may be known per se (see, for instance, “Evaluation of Phase-Diversity Techniques for Solar-Image Restoration” by Paxman et al., Astrophysical Journal, 1996). Paxman splits incoming light and images a first split part of the light normal imaging optics and a second part with imaging optics that differ from the normal imaging optics by applying phase diversity. Hence Paxman uses two images for each time point and a plurality of time points for which each time two images are obtained with the normal optics and the phase diversity optics. Paxman mentions the possibility of using more images for each time points, by feeding split off light to a plurality of imaging optics that each apply a different phase diversity. But the required overhead makes use of much more than two images for each time point impractical. At each time point the same plurality of imaging optics is used. The present device uses a far larger number of phase diversity settings in the course of time, obtained by varying the settings of the adaptive optics. Moreover, the present device and method use no feedback about the current turbulence of the atmosphere, in particular not to select the settings of the adaptive optics.

It is noted that United States Patent Application US 2010/001901 (William M. Rice University) discloses a method and apparatus for developing radar scene and target profiles based on the compressive sensing concept. The radar reflectivity profile is recovered from the received radar wave sequence using a compressible or sparse representation of the radar reflectivity profile, in combination with knowledge of the outgoing wave form. US 2010/001901 fails to suggest the use of compressive sensing in optical applications and also fails to mention turbulence compensation.

A method of producing turbulence compensated images is provided, the method comprising the steps of:
registering a series of images produced by the camera while adapting the optical element, whereby images are registered that are obtained with mutually different adaptations of the optical element;
estimating turbulence affecting the images in the registered series of images from the series of images, and
computing compensated image data, by compensating the turbulence in at least one image after the at least one image has been captured by the camera, by using the estimated turbulence and a turbulence compensation computation algorithm.

In a preferred embodiment, the step of estimating turbulence may involves a phase diversity technique. The step of compensating turbulence may involve a compressive sensing technique. The adaptive optical element may produces an image space which comprises the optimal configuration of the adaptive optical element.

In the present method, it is preferred that the adaptive optical element is controlled without feedback. That is, turbulence estimates are not used for controlling the adaptive optical element, as in the Prior Art. The method is therefore preferably feedbackless.

Additionally a computer program product is provided, comprising processor-executable instructions for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

In an embodiment a device for producing turbulence compensated image data is provided, the device comprising:
a processor,
a memory for storing processor-executable instructions,
a camera for producing images, and
an adaptive optical element for altering optical treatment of light incident on the camera,
   wherein the processor is configured to control the adaptive optical element, and wherein the processor-executable instructions are configured to make the processor carry out the steps of:
applying a plurality of mutually different adaptations to the optical element at different times;
capturing a series of images produced by the camera at the times of mutually different adaptations of the optical element;
determining a maximum likelihood estimate of object parameters that are representative of compensated image data, using an expression for the likelihood of the object parameters and aberration parameters due to turbulence given the captured images and the adaptations to the optical element at the times that the images were captured.

### BRIEF DESCRIPTION OF THE DRAWING

The foregoing will further be explained below with reference to exemplary embodiments illustrated in the accompanying drawings, in which:

FIG. 1 schematically shows an embodiment of an imaging device

FIG. 2 schematically shows an embodiment of an adaptive optical element in cross-sectional view.

### DETAILED DESCRIPTION OF EXEMPLARY EMBODIMENTS

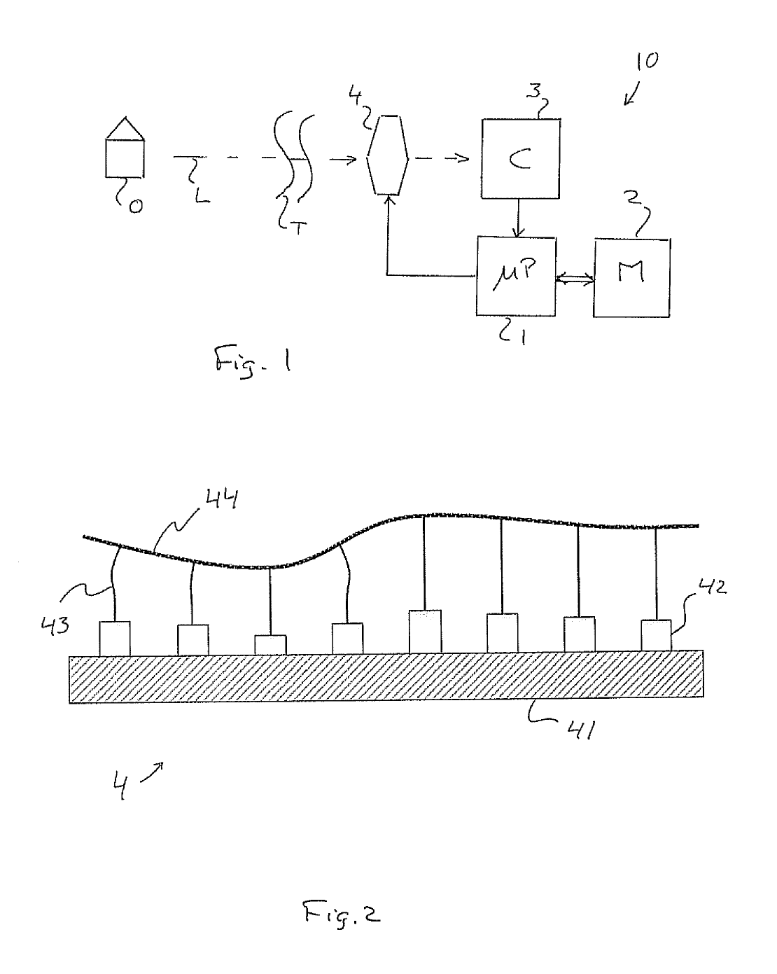

The device 10 shown merely by way of non-limiting example in FIG. 1 comprises a processor 1, a memory 2, a camera 3 and an adaptive optical element 4. The processor 1 may be constituted by a commercially available microprocessor (μP). The memory (M) 2 may be constituted by commercially available RAM (Random Access Memory) and stores both data and processor-executable instructions. There are several categories of instructions (that is, several software programs) stored in the memory 2: instructions to control the adaptive optical element 4, instructions to control the camera 3, instructions to estimate turbulence and instructions to compensate turbulence. The device 10 may further comprise a display screen (not shown) and/or a keyboard or other input/output apparatus.

The camera (C) 3 may be a commercially available CCD camera or similar device. The camera 3 captures digital images based on impinging light L and sends these digital images to the processor 1, where they are processed and stored in the memory 2. The process including capturing and storing is referred to as registering.

The adaptive optical element 4 is preferably constituted by a deformable mirror, which may be known per se. Suitable deformable mirror designs are disclosed in WO 2005/050283 (TNO) and U.S. Pat. No. 5,719,846 (Sharp).

As shown in FIG. 1, light L originating from an object 0 passes through (and/or is reflected by) the adaptive optical element 4 of the device 10. Between the object O and the adaptive optical element 4, the light experiences atmospheric turbulence T (symbolically illustrated in FIG. 1 by curved lines in the light path). The camera 3 captures the image of the object O and produces digital signals representing this image, which digital signals are forwarded to the processor 1. However, the image of the object O will not be perfect, as it is affected by both the turbulence T and the adaptive optical element 4.

According to one aspect, the adaptive optical element is varied by the processor 1 so as to provide, in different images, different distortions, such as different degrees of being out-of-focus (either locally, in parts of the image, or globally, in the entire image). Although some images may be produced having identical settings of the adaptive optical element 4, it is preferred that all images, at least all images of a series, are produced using distinct setting, thus leading to distinct distortions induced by the adaptive optical element (it will be understood that image distortions induced by atmospheric turbulence and image distortions induced by the adaptive optical element may cancel each other, at least partially, thus accidentally leading to identical overall image distortions in different images). The adaptations of the optical element 4, and hence the image distortions, may be random. However, they may also follow a predetermined pattern. The series of images having different induced distortions is used to estimate the distortion induced by the atmospheric turbulence. This typically requires a large number of images.

The captured images obtained with the variations of the distortion are used to estimate the turbulence and the best compensated image. At least one image is compensated using the estimated turbulence. Estimating turbulence and the best compensated image may be achieved using a phase diversity interpolation technique which may be known per se (see, for instance, “Evaluation of Phase-Diversity Techniques for Solar-Image Restoration” by Paxman et al., Astrophysical Journal, 1996). In an embodiment, this involves a maximum likelihood estimation of the best compensated image in view of the captured images. Paxman discusses expressions for the probability of a captured image given an object scene and aberration parameters due to turbulence. This expression is used to formulate the inverse problem of expressing the likelihood of the object parameters (i.e. parameters defining the true image) and the aberration parameters given a plurality of captured images. The object parameters (i.e. the object image) and/or the aberration parameters for different images at the maximum of this likelihood are determined and used as an estimate of the object parameters and/or the aberration parameters.

In order to significantly reduce the number of images required to estimate (the image distortions induced by) the atmospheric turbulence, the present device and method advantageously use compressed sensing techniques. Such techniques, which are also known as sparse sampling techniques, are capable of reconstructing data using far less samples than required by the Nyquist/Shannon criterion. According to this criterion, the sampling frequency should be at least half the highest frequency in a signal if that signal is to be fully reconstructed from the samples. In other words, the number of signal samples is determined by the highest frequency of the signal (the CD, for example, uses 44100 samples per second to faithfully render sound of up to 20 kHz). However, sparse sampling techniques, which are known per se, utilize additional information about the signal to fully reconstruct it while using far less samples.

Thus, additional information about the images can be used to significantly reduce the number of images used to estimate the distortion, in particular when the settings of the adaptive optical element are varied randomly. This additional information may be derived from other images in a series: if the images are captured in a relatively rapid succession, and if the object does not move relative to the camera, the only differences between the images will be caused by the different distortions. If one part of the distortions is known, as it is induced by the processor-controlled adaptive optical element, the atmospheric distortion can be estimated.

It is noted that the device and method use a combination of features that may be known per se and may be, as such, available as commercial software programs. For example, a turbulence compensation algorithm may be known per se, and may use a known compressive sensing technique. In addition, estimating the amount of turbulence may be carried out using a known phase diversity technique.

Compensating turbulence may be carried out by interpolation, provided that images are available “around” the (virtual) distortion-free image, and provided that an indication exists of the relative position of this distortion-free image relative to the available images. In other words, a measure should be derived of the amount of distortion in each image. Part of this measure will of course be based on the (processor-controlled) settings of the adaptive optical element, and part of this measure will have to be estimated, for example by averaging a number of images while compensating the settings of the adaptive optical element.

In an embodiment, images captures at different settings of the adaptive optical element 4 may be used for interpolation of different regions of the compensated image, selected based on the estimated distortion from the different registered images in the different regions. In other words, a measure should be derived of the amount of distortion in each image region. Part of this measure will of course be based on the (processor-controlled) settings of the adaptive optical element, and part of this measure will have to be estimated, for example by averaging a number of images while compensating the settings of the adaptive optical element.

A merely exemplary embodiment of a deformable mirror, which may serve as adaptive optical element 4, is illustrated in FIG. 2. In the embodiment of FIG. 2, the deformable mirror comprises a support structure 41 upon which a series of actuators 42 are mounted. The actuators 42 can preferably be controlled individually. Elastic connections 43 connect each actuator 42 to a flexible optical membrane 44. It can be seen that selective deformations of the optical membrane 44, effected by the actuators 42, result in certain deformations of the image produced by the light (L in FIG. 1). In this way, the image can be deliberately, and in a controlled manner, be distorted, so as to produce a series of differently distorted images. These images can then be used for interpolation, to determine the actual turbulence.

The device and method are based upon the insight that by interpolation of several images affected differently by turbulence, the actual turbulence can be estimated, for example by using phase diversity techniques. The device and method benefit from the further insight that turbulence compensation can be synthesized on the basis of a sparsely sampled turbulence compensation configuration space using compressive sensing or similar techniques.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

According to one aspect a device for producing turbulence compensated images is provided, the device comprising: a processor (1), a memory (2) for storing processor-executable instructions, a camera (3) for producing images, and an adaptive optical element (4) for altering properties of light incident on the camera (3), In the device the processor (1) is configured to control the adaptive optical element (4), and wherein the processor-executable instructions are configured to make the processor carry out the steps of: registering a series of images produced by the camera (3) while adapting the optical element (4), thus registering images having different optical properties, estimating any turbulence affecting the images by interpolating the registered series of images, and compensating any turbulence in at least one image by using the estimated turbulence and a turbulence compensation algorithm. In a further embodiment the processor-executable instructions are configured for estimating turbulence using a phase diversity technique. The processor-executable instructions may be configured for carrying out the step of compensating turbulence using a compressive sensing technique. The processor-executable instructions may be configured for carrying out the step of compensating turbulence using an interpolation technique. The processor-executable instructions may be configured for making the adaptive optical element (4) produce an image space which comprises the optimal configuration of the adaptive optical element (4).

In an embodiment the adaptive optical element (4) comprises a deformable mirror. The device may comprise a display screen for displaying the turbulence corrected image.

Similarly, a method of producing turbulence compensated images is provided, the method comprising the steps of: registering a series of images while adapting an adaptive optical element (4) so as to alter properties of light incident on a camera (3), thus registering images having different optical properties; estimating any turbulence affecting the images by interpolating the registered series of images, and compensating any turbulence in at least one image by using the estimated turbulence and a turbulence compensation algorithm.

In an embodiment the step of estimating turbulence involves a phase diversity technique. The step of compensating turbulence may involve a compressive sensing technique. The adaptive optical element (4) may produce an image space which comprises the optimal configuration of the adaptive optical element (4). The adaptive optical element (4) may be controlled without feedback. A computer program product (e.g. a magnetic or optical disk or a semi-conductor memory may be provided comprising processor-executable instructions for carrying out the method.

1. A device for producing turbulence compensated image data, the device comprising:
a processor (1),
a memory (2) for storing processor-executable instructions,
a camera (3) for producing images, and
an adaptive optical element (4) for altering properties of light incident on the camera (3),
wherein the processor (1) is configured to control the adaptive optical element (4), and wherein the processor-executable instructions are configured to make the processor carry out the steps of:
registering a series of images produced by the camera (3) while adapting the optical element (4), whereby images are registered that are obtained with mutually different adaptations of the optical element (4);
estimating turbulence affecting the images in the registered series of images from the series of images, and
computing compensated image data, by compensating the turbulence in at least one image after the at least one image has been captured by the camera by using the estimated turbulence and a turbulence compensation computation algorithm.

2. The device according to claim 1, wherein the processor executable instructions are configured to make the processor perform said steps without feedback about the current turbulence of the atmosphere, registering the series of images using a series of adapted settings of the optical element (4) that are selected at random or following a predetermined pattern.

3. The device according to claim 1, wherein the processor-executable instructions are configured for estimating turbulence using a phase diversity technique.

4. The device according to claim 1, wherein the processor-executable instructions are configured for carrying out the step of compensating turbulence using a compressive sensing technique.

5. The device according to claim 1, wherein the processor-executable instructions are configured for carrying out the step of compensating turbulence using an interpolation technique.

6. The device according to claim 1, wherein the processor-executable instructions are configured for making the adaptive optical element (4) produce an image space which comprises the optimal configuration of the adaptive optical element (4).

7. The device according to claim 1, wherein the adaptive optical element (4) comprises a deformable mirror.

8. The device according to claim 1, further comprising a display screen for displaying the turbulence corrected image.

9. The device according to claim 1, wherein the processor-executable instructions are configured to make the processor carry out said step of estimating turbulence by distinguishing estimated turbulence for different regions within the images of the series, and said step of computing compensated image data, by compensating the turbulence in respective regions in said at least one image using the estimated turbulence for the respective regions.

10. A method of producing turbulence compensated image data, the method comprising the steps of:
registering a series of images produced by the camera (3) while adapting the optical element (4), whereby images are registered that are obtained with mutually different adaptations of the optical element (4);
estimating turbulence affecting the images in the registered series of images from the series of images, and
computing compensated image data, by compensating the turbulence in at least one image after the at least one image has been captured by the camera, by using the estimated turbulence and a turbulence compensation computation algorithm.

11. The method according to claim 10, comprising performing said steps without feedback about the current turbulence of the atmosphere, the series of images being registered using a series of adapted settings of the optical element (4) that are selected at random or following a predetermined pattern.

12. The method according to claim 10, wherein the step of estimating turbulence involves a phase diversity technique.

13. The method according to claim 10, wherein the step of compensating turbulence involves a compressive sensing technique.

14. The method according to claim 10, wherein the adaptive optical element (4) produces an image space which comprises the optimal configuration of the adaptive optical element (4).

15. The method according to claim 10, wherein the adaptive optical element (4) is controlled without feedback.

16. The method according to claim 10, wherein said step of estimating turbulence distinguishes estimated turbulence for different regions within the images of the series, and said step of computing compensated image data, comprises compensating the turbulence in respective regions in said at least one image using the estimated turbulence for the respective regions.

17. A machine readable medium comprising processor-executable instructions for carrying out the method comprising the steps of:
registering a series of images produced by a camera (3) while adapting an optical element (4), whereby images are registered that are obtained with mutually different adaptations of the optical element (4);
estimating turbulence affecting the images in the registered series of images from the series of images, and
computing compensated image data, by compensating the turbulence in at least one image after the at least one image has been captured by the camera, by using the estimated turbulence and a turbulence compensation computation algorithm.

18. A device for producing turbulence compensated image data, the device comprising:
a processor (1),
a memory (2) for storing processor-executable instructions,
a camera (3) for producing images, and
an adaptive optical element (4) for altering optical treatment of light incident on the camera (3),
wherein the processor (1) is configured to control the adaptive optical element (4), and wherein the processor-executable instructions are configured to make the processor carry out the steps of:
applying a plurality of mutually different adaptations to the optical element (4) at different times;
capturing a series of images produced by the camera (3) at the times of mutually different adaptations of the optical element (4);
determining a maximum likelihood estimate of object parameters that are representative of compensated image data, using an expression for the likelihood of the object parameters and aberration parameters due to turbulence given the captured images and the adaptations to the optical element (4) at the times that the images were captured.

19. A method of producing turbulence compensated image data, the method comprising:
controlling an adaptive optical element (4) to provide a plurality of mutually different adaptations to the optical element (4) at different times;
capturing a series of images produced by the camera (3) at the times of mutually different adaptations of the optical element (4);
determining a maximum likelihood estimate of object parameters that are representative of compensated image data, using an expression for the likelihood of the object parameters and aberration parameters due to turbulence given the captured images and the adaptations to the optical element (4) at the times that the images were captured.
